(19) United States
(12) Patent Application Publication
(10) Pub. No.: US 2007/0028289 A1
(43) Pub. Date: Feb. 1, 2007

(54) Picture signal processor and picture signal processing method

(75) Inventor: Naozumi Koshino, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/489,507

(22) Filed: Jul. 20, 2006

(30) Foreign Application Priority Data
Jul. 29, 2005 (JP) 2005-220300

(51) Int. Cl. H04N 7/16

(52) U.S. Cl. 725/136; 725/135

(57) ABSTRACT

According one embodiment, metadata outputted from a server device is acquired on the basis of a request for acquisition of metadata, and it is determined whether or not an amount of information of the acquired metadata is insufficient. When it is determined that the amount of information of the metadata is insufficient, a request for acquisition of header information of contents is made with respect to the server device, and the insufficient amount of information of the metadata is complemented by analyzing the header information acquired from the server device.

### CROSS-REFERENCE TO RELATED APPLICATIONS

This application is based upon and claims the benefit of priority from Japanese Patent Application No. 2005-220300, filed Jul. 29, 2005, the entire contents of which are incorporated herein by reference.

### BACKGROUND

1. Field

One embodiment of the invention relates to a picture signal processor and a picture signal processing method suitable for use in, for example, digital television broadcasting receivers, and in particular, to a picture signal processor and a picture signal processing method for acquiring contents from a server device via home networking.

2. Description of the Related Art

As is commonly known, in recent years, digitization of household electric appliances has been developed. For example, in Japan, flat-screen digital televisions (TVs) of a liquid crystal, plasma or the like, which have a function of receiving and reproducing satellite broadcasting satellite (BS) digital broadcasting and terrestrial digital broadcasting, HDD-DVD (digital versatile disk) recorders which performs digital recording onto built-in hard disk drives (HDDs), and the like have been rapidly diffused in families.

Among the digital household electric appliances, there are many appliances including personal computers (PCs), which have a network connection function. Therefore, for example, a contents display device such as a digital TV operates as a client device, and accesses contents stored in a PC or a HDD-DVD recorder having a server function which is in an another room via home networking. This makes it possible to enjoy the contents without moving to the place where the contents physically exist.

By the way, when a plurality of server devices are connected over the network in home networking as described above, server software executed by the respective server devices are different from one another. Consequently, amounts of information of metadata serving as attribute information of contents to be provided from the respective server devices to a client device are respectively different from one another. For this reason, when the client device displays the metadata acquired from the server devices by graphical user interface (GUI), a difference is brought about between amounts of information to be displayed, i.e., amounts of information to be provided to a user for every server device.

Jpn. Pat. Appln. KOKAI Publication No. 2004-362099 discloses the following configuration. A film roll file having still image data stored therein, and an index information file having index information of the still image data stored therein are stored in a server. The both files are made to be metadata corresponding to contents by setting uniform resource identifiers (URIs) thereto, whereby a client acquires an URI from the contents information (metadata), and transmits a data request to a server. This makes it possible for the client to selectively receive contents, still image, and index information.

However, in the Jpn. Pat. Appln. KOKAI Publication No. 2004-362099 described above, there is no description on the point that an improvement is actively made onto the problem that a difference is brought about between the amounts of information to be displayed, i.e., in the amounts of information provided to a user for every server device because the amounts of information of metadata to be provided from the respective server devices connected to home networking to the client device are different from one another.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows one embodiment of the invention, and is a diagram shown for schematically explaining one example of a digital television broadcasting receiver and a network system configured with a central focus thereon;

FIG. 2 is a block diagram shown for explaining a main signal processing system of the digital television broadcasting receiver in the embodiment;

FIG. 3 is a block diagram shown for explaining home networking with a central focus on the digital television broadcasting receiver in the embodiment;

FIG. 4 is a view shown for explaining one example of a still image list displayed on the digital television broadcasting receiver in the embodiment;

FIG. 5 is a view shown for explaining another example of a still image list displayed on the digital television broadcasting receiver in the embodiment; and

FIG. 6 is a flowchart shown for explaining a main processing operation of the digital television broadcasting receiver in the embodiment.

### DETAILED DESCRIPTION

Various embodiments according to the invention will be described hereinafter with reference to the accompanying drawings. In general, according to one embodiment of the invention, metadata outputted from a server device is acquired on the basis of a request for acquisition of metadata, and it is determined whether or not an amount of information of the acquired metadata is insufficient. When it is determined that the amount of information of the metadata is insufficient, a request for acquisition of header information of contents is made with respect to the server device, and the insufficient amount of information of the metadata is complemented by analyzing the header information acquired from the server device.

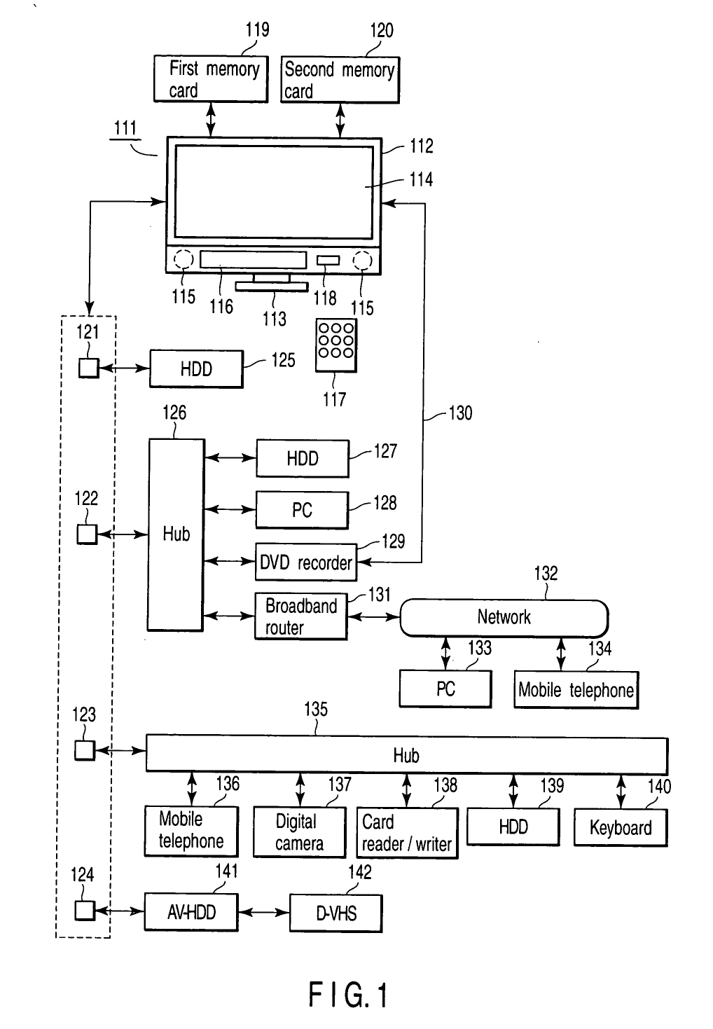

FIG. 1 schematically shows an appearance of a digital television broadcasting receiver 111 which will be described in this embodiment, and one example of a network system configured with a central focus on the digital television broadcasting receiver 111.

Namely, the digital television broadcasting receiver 111 is mainly configured of a flat type cabinet 112 and a supporting table 113 which supports the cabinet 112 so as to be made to stand up. The cabinet 112 is provided with a flat-screen panel type graphic display 114 composed of, for example, an SED (surface-conduction electron-emitter display) display panel, a liquid crystal display panel, or the like, speakers 115, an operating unit 116, an optical receiver unit 118 which receives operation information transmitted from a remote controller 117, and the like.

Further, a first memory card 119 such as, for example, an secure digital (SD) memory card, a multimedia card (MMC), and a memory stick is made attachable to and detachable from the digital television broadcasting receiver 111. Information such as programs and photographs is recorded to and reproduced from the first memory card 119.

Moreover, a second memory card (IC card) 120 having, for example, contract information and the like recorded therein is made attachable to and detachable from the digital television broadcasting receiver 111. Information is recorded to and reproduced from the second memory card 120.

Further, the digital television broadcasting receiver 111 has a first local area network (LAN) terminal 121, a second LAN terminal 122, a universal serial bus (USB) terminal 123, and an IEEE1394 terminal 124.

Among them, the first LAN terminal 121 is used as a LAN compliant HDD dedicated port, and is used for recording and reproducing information by Ethernet (registered trademark) to and from a LAN compliant HDD 125 which is a connected network attached storage (NAS).

In this way, by providing the first LAN terminal 121 serving as a LAN compliant HDD dedicated port, information of a program in a high-definition television picture quality can be stably recorded to the HDD 125 without being influenced by other network environments, network statuses of use, and the like.

Further, the second LAN terminal 122 is used as a general LAN compliant port using Ethernet (registered trademark). The second LAN terminal 122 is used for connecting devices such as, for example, a LAN compliant HDD 127, a PC 128, and a DVD recorder 129 incorporating HDD via a hub 126, and for transmitting and receiving information to and from these devices.

In this case, the PC 128 and the DVD recorder 129 are configured as UPnP (universal plug and play) compliant devices which respectively have not only a function for operating as a contents server device in home networking, but also service for providing URI information necessary for accessing contents.

Note that, with respect to the DVD recorder 129, digital information communicated via the second LAN terminal 122 are information of only a control system. For this reason, a dedicated analog transmission line 130 is provided in order to transmit/receive analog image and audio information to/from the digital television broadcasting receiver 111.

Moreover, the second LAN terminal 122 is used for connecting to a network 132 such as, for example, Internet via a broadband router 131 connected to the hub 126, and for transmitting/receiving information to/from a PC 133, a mobile telephone 134, or the like via the network 132.

Further, the above-described USB terminal 123 is used as a general USB compliant port, and is used for connecting USB devices such as, for example, a mobile telephone 136, a digital camera 137, a card reader/writer 138 for a memory card, an HDD 139, and a keyboard 140 via a hub 135, and for transmitting/receiving information to/from the USB devices.

Moreover, for example, the IEEE1394 terminal 124 is used for serially connecting an AV-HDD 141, a D (digital)-VHS (video home system) 142, and the like, and for transmitting/receiving information to/from the devices.

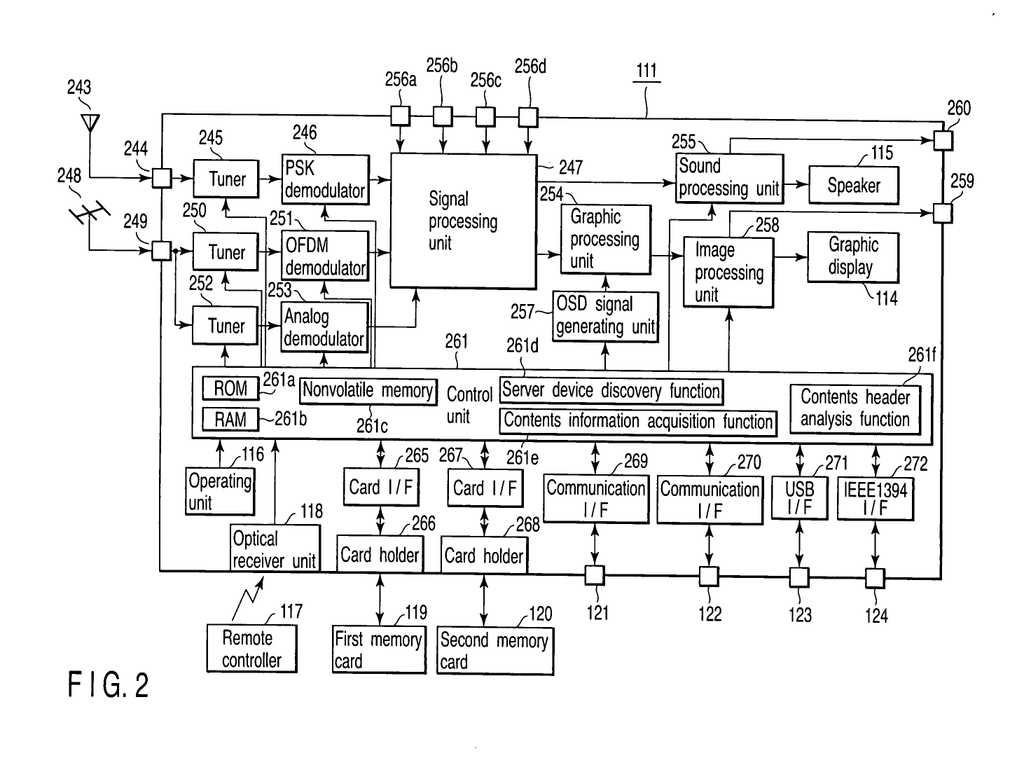

FIG. 2 shows a main signal processing system of the digital television broadcasting receiver 111 described above. Namely, by supplying a satellite digital television broadcasting signal received by an antenna 243 for receiving BS/CS (communication satellite) digital broadcasting to a tuner 245 for satellite digital broadcasting via an input terminal 244, a broadcasting signal on a desired channel is tuned in.

Then, the broadcasting signal tuned by the tuner 245 is supplied to a phase shift keying (PSK) demodulator 246, and demodulated into digital picture signal and audio signal. Thereafter, the signals are outputted to a signal processing unit 247.

Further, by supplying a terrestrial digital television broadcasting signal received by an antenna 248 for receiving terrestrial broadcasting to a tuner 250 for terrestrial digital broadcasting via an input terminal 249, a broadcasting signal on a desired channel is tuned in.

Then, the broadcasting signal tuned by the tuner 250 is supplied to an OFDM (orthogonal frequency division multiplexing) demodulator 251, and demodulated into digital picture signal and audio signal. Thereafter, the signals are outputted to the signal processing unit 247.

Further, by supplying a terrestrial analog television broadcasting signal received by the antenna 248 for receiving terrestrial broadcasting described above to a tuner 252 for terrestrial analog broadcasting via the input terminal 249, a broadcasting signal on a desired channel is tuned in. Then, the broadcasting signal tuned by the tuner 252 is supplied to an analog demodulator 253, and demodulated into analog picture signal and audio signal. Thereafter, the signals are outputted to the signal processing unit 247.

Here, the signal processing unit 247 applies predetermined digital signal processing selectively to the digital picture signals and audio signals respectively supplied from the PSK demodulator 246 and the OFDM demodulator 251, and outputs the signals to a graphic processing unit 254 and a sound processing unit 255.

Further, a plurality (in the case of the drawing, four) of input terminals 256a, 256b, 256c, and 256d are connected to the signal processing unit 247. These input terminals 256a to 256d make it possible for analog picture signals and audio signals to be input from the outside of the digital television broadcasting receiver 111.

The signal processing unit 247 selectively digitizes analog picture signals and audio signals supplied respectively from the analog demodulator 253 and the respective input terminals 256a to 256d, and applies predetermined digital signal processing onto the digitized picture signals and audio signals. Thereafter, the signal processing unit 247 outputs the signals to the graphic processing unit 254 and the sound processing unit 255.

The graphic processing unit 254 has a function in which an on-screen display (OSD) signal generated in an OSD signal generating unit 257 is superimposed onto a digital picture signal supplied from the signal processing unit 247 to be outputted. The graphic processing unit 254 can selectively output an output picture signal of the signal processing unit 247 and an output OSD signal of the OSD signal-generating unit 257, and can output the both outputs so as to be combined such that the both outputs respectively structure the half of a screen.

A digital picture signal outputted from the graphic processing unit 254 is supplied to an image processing unit 258. The image processing unit 258 converts the input digital picture signal into an analog picture signal in a format which can be displayed on the aforementioned graphic display 114. Thereafter, the image processing unit 258 outputs the signal to be displayed as an image on the graphic display 114, and leads it to the outside via an output terminal 259.

Further, the sound processing unit 255 converts the input digital audio signal into an analog audio signal in a format which can be reproduced through the aforementioned speakers 115. Thereafter, the sound processing unit 255 outputs the signal to be reproduced as sound through the speakers 115, and leads it to the outside via an output terminal 260.

Here, all the operations of the digital television broadcasting receiver 111, including the various receiving operations described above, are overall controlled by a control unit 261. The control unit 261 incorporates a central processing unit (CPU) and the like. The control unit 261 receives operation information from the operating unit 116, or receives operation information transmitted from the remote controller 117 via the optical receiver unit 118, and respectively controls the respective units such that the operation contents thereof are reflected.

In this case, the control unit 261 mainly utilizes a read only memory (ROM) 261a having a control program executed by the CPU stored therein, a random access memory (RAM) 261b which provides a work area to the CPU, and a nonvolatile memory 261c in which various setting information and control information, etc. are stored.

Further, with respect to the control unit 261, the first memory card 119 is connected to an attachable card holder 266 via a card interface (I/F) 265. As a consequence, the control unit 261 can transmit/receive information via the card I/F 265 to/from the first memory card 119 mounted to the card holder 266.

Moreover, with respect to the control unit 261, the second memory card 120 is connected to an attachable card holder 268 via a card I/F 267. As a consequence, the control unit 261 can transmit/receive information via the card I/F 267 to/from the second memory card 120 mounted to the card holder 268.

Further, the control unit 261 is connected to the first LAN terminal 121 via a communication I/F 269. As a consequence, the control unit 261 can transmit/receive information via the communication I/F 269 to/from the LAN compliant HDD 125 connected to the first LAN terminal 121. In this case, the control unit 261 has a DHCP (dynamic host configuration protocol) server function, and controls so as to assign an internet protocol (IP) address to the LAN compliant HDD 125 connected to the first LAN terminal 121.

Moreover, the control unit 261 is connected to the second LAN terminal 122 via a communication I/F 270. As a consequence, the control unit 261 can transmit/receive information via the communication I/F 270 to/from the respective devices (refer to FIG. 1) connected to the second LAN terminal 122.

Further, the control unit 261 is connected to the USB terminal 123 via a USB I/F 271. As a consequence, the control unit 261 can transmit/receive information via the USB I/F 271 to/from the respective devices (refer to FIG. 1) connected to the USB terminal 123.

Moreover, the control unit 261 is connected to the IEEE1394 terminal 124 via an IEEE1394 I/F 272. As a consequence, the control unit 261 can transmit/receive information via the IEEE1394 I/F 272 to/from the respective devices (refer to FIG. 1) connected to the IEEE1394 terminal 124.

Further, the control unit 261 has a server device discovery function 261d utilizing UPnP, a contents information acquisition function 261e utilizing UPnP, and a contents header analysis function 261f.

Namely, the control unit 261 can discover UPnP compliant devices on a network by using a discovery function in UPnP by the server device discovery function 261d. For example, the server device discovery function 261d can discover the PC 128 having a server function connected to home networking by using a discovery function in UPnP.

Further, the control unit 261 can acquire URI information necessary for accessing contents in the UPnP compliant device by controlling a UPnP compliant device by using a control function in UPnP by the contents information acquisition function 261e. For example, the contents information acquisition function 261e can control the PC 128 to acquire URI information necessary for accessing contents accumulated in an HDD or the like in the PC 128 from the PC 128.

Moreover, the control unit 261 acquires contents and header information thereof from the server device (PC 128) by using the URI information acquired by the contents information acquisition function 261e, and can acquire metadata by analyzing the acquired header information by the contents header analysis function 261f. Information of the metadata is displayed on the graphic display 114 by GUI.

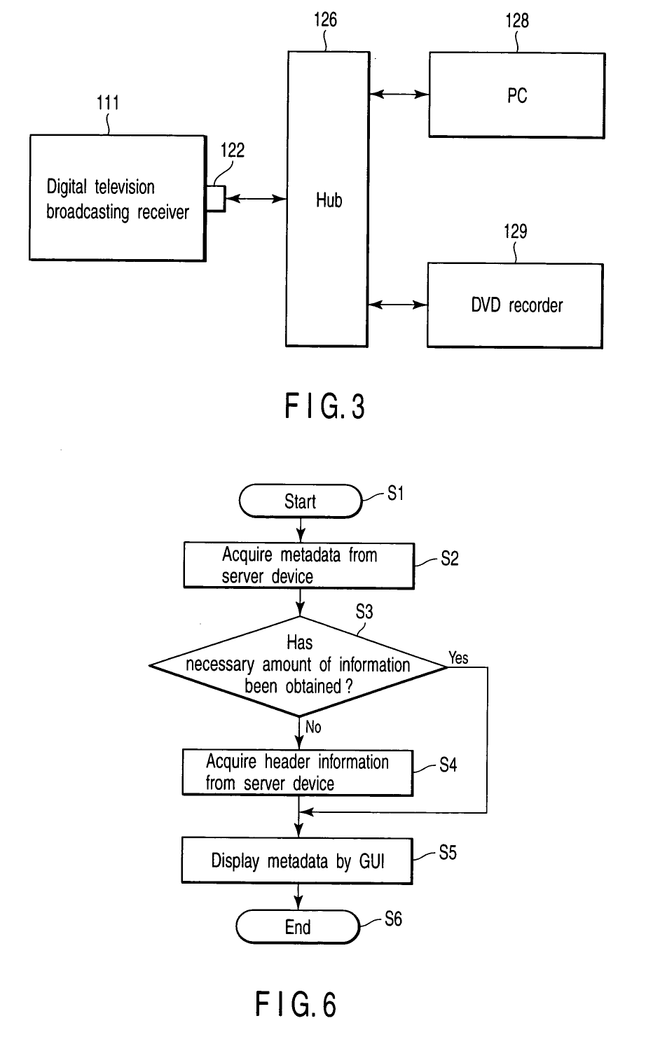

FIG. 3 shows a part of home networking in the network system shown in FIG. 1. Namely, as described above, with respect to the digital television broadcasting receiver 111 serving as a client device, the second LAN terminal 122 thereof is connected via the hub 126 to the PC 128 and the DVD recorder 129 which can be operated as server devices.

Here, consideration will be given for a case in which the digital television broadcasting receiver 111 accesses the PC 128 to select desired still image contents from a plurality of still image contents [JPEG (joint photographic experts group) data] stored in the built-in HDD thereof, and to display the contents on the graphic display 114.

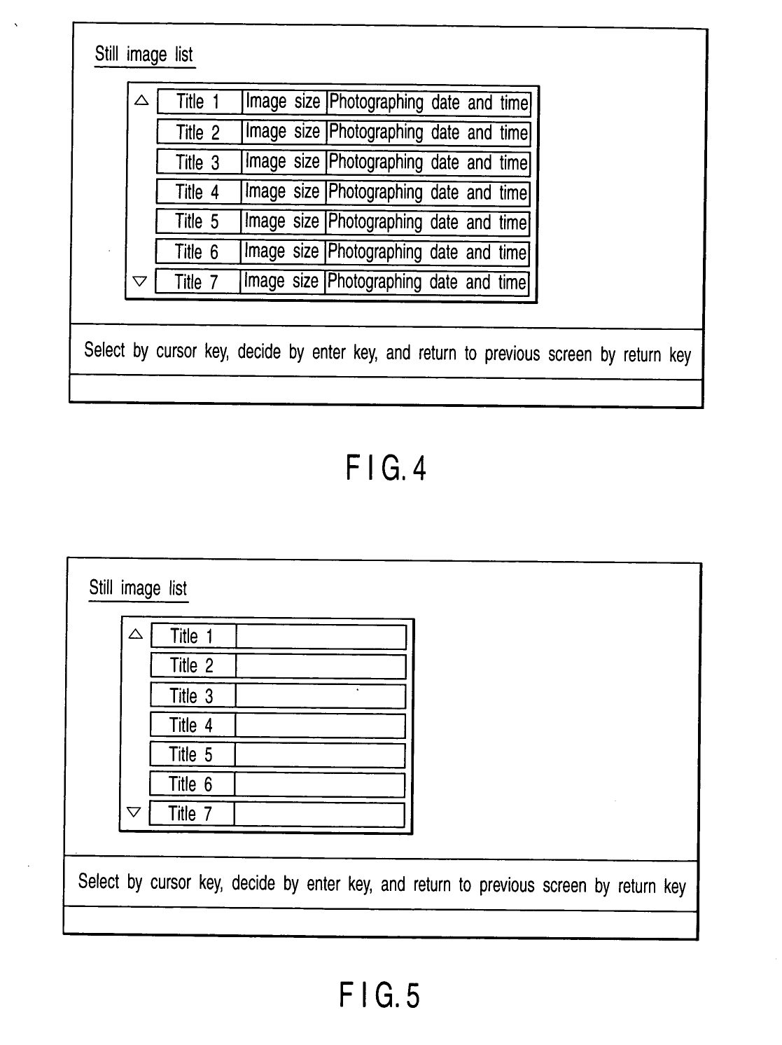

In this case, the digital television broadcasting receiver 111 makes a request for acquisition of metadata corresponding to the respective still image contents stored in the built-in HDD with respect to the PC 128. Then, the PC 128 outputs requested metadata, and the digital television broadcasting receiver 111 displays a list of the still image contents stored in the PC 128 on the graphic display 114 as shown in FIG. 4 on the basis of the metadata acquired form the PC 128.

At this time, the PC 128 has a function by which information denoting “Title”, “Image size”, “Photographing date and time”, or the like can be outputted as metadata for still image contents. In addition, a user can select and determine desired still image contents to be displayed by controlling the remote controller 117 from the list screen.

On the other hand, consideration will be given for a case in which the digital television broadcasting receiver 111 accesses the DVD recorder 129 to select desired still image contents from still image contents [JPEG data] stored in the built-in HDD thereof to be displayed on the graphic display 114.

In this case as well, the digital television broadcasting receiver 111 makes a request for acquisition of metadata corresponding to the respective still image contents stored in the built-in HDD with respect to the DVD recorder 129. As a consequence, the DVD recorder 129 outputs requested metadata, and the digital television broadcasting receiver 111 displays a list of the still image contents stored in the DVD recorder 129 on the graphic display 114 on the basis of the metadata acquired form the DVD recorder 129.

At this time, it is assumed that the DVD recorder 129 merely has a function of outputting only information denoting “Title” as metadata corresponding to still image contents. In this case, in the digital television broadcasting receiver 111, only titles of the still image contents can be displayed as a still image list, and amounts of information to be provided to a user are made less than those in the case of the PC 128, as shown in FIG. 5.

In such a case, the digital television broadcasting receiver 111 makes a request for acquisition of still image contents with respect to the DVD recorder 129 by using the URI information acquired by the contents information acquisition function 261e. Namely, a plurality of still image contents are stored in the built-in HDD of the DVD recorder 129. Attribute information, such as titles, image sizes, and photographing date and time, which are usually obtained at the time of photographing by a digital still camera, are included as header information in portions of the contents.

Then, the DVD recorder 129 outputs still image contents to the digital television broadcasting receiver 111 at the request from the digital television broadcasting receiver 111. Then, the digital television broadcasting receiver 111 acquires the header information from the contents outputted from the DVD recorder 129, and obtains metadata denoting an image size and a photographing date and time which are insufficient information by analyzing the acquired header information by the contents header analysis function 261f of the control unit 261.

As a consequence, the digital television broadcasting receiver 111 can display “Title”, “Image size”, and “Photographing date and time” as a still image list by collecting the information (titles) of the metadata which the DVD recorder 129 has outputted, and the metadata (image sizes and photographing dates and times) acquired from the header information together.

FIG. 6 shows a flowchart in which operations for displaying metadata described above are summarized. These operations are started (block S1) when the digital television broadcasting receiver 111 issues a request for acquisition of metadata to a predetermined server device connected to the home networking.

Then, the digital television broadcasting receiver 111 acquires metadata outputted from the server device in block S2, and determines whether or not metadata in a necessary amount of information can be acquired in block S3, i.e., whether or not the amount of information of the acquired metadata is insufficient.

Here, when it is determined that metadata in a necessary amount of information cannot be acquired (NO), the digital television broadcasting receiver 111 acquires header information from the server device in block S4, and obtains metadata by analyzing the acquired header information.

Then, after block S4, or when it is determined that metadata in a necessary amount of information can be acquired (YES) in the block S3, the digital television broadcasting receiver 111 displays the acquired metadata by GUI in block S5, and terminates the processing (block S6).

In accordance with the embodiment described above, when an amount of information of metadata which a server device has outputted is insufficient, the digital television broadcasting receiver 111 acquires header information from the server device, and complements the insufficiency in the amount of information of the metadata by obtaining necessary metadata from the header information. As a consequence, it is possible to reduce a difference between amounts of information of metadata to be provided to a user for every server device.

Here, a necessary amount of information of metadata is set in advance every type of contents, for example, so as to be three types such of title, image size, and photographing date and time, in a case of still image contents which have been photographed by a digital still camera. It can be determined whether or not an amount of information is insufficient by being compared with an amount of information of metadata which the server device has outputted.

Further, in the embodiment described above, it has been described that a list with respect to still image contents stored in a server device is displayed. However, it is not limited thereto, and it is possible to display a list with respect to moving image contents stored in a server device. In this case, information of a total number of hours is not included in metadata provided from a server device in some cases. In this case as well, header information is acquired from the server device, and it is possible to display those in a list by analyzing information of a total number of hours therein.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A picture signal processor comprising:
a metadata acquisition unit configured to make a request for acquisition of metadata corresponding to contents with respect to a server device having the contents stored therein, and to acquire the metadata outputted from the server device on the basis of the request;
a determination unit configured to determine whether or not an amount of information of the metadata acquired by the metadata acquisition unit is insufficient;
a header information acquisition unit configured to, when the determination unit determines that the amount of information of the metadata is insufficient, make a request for acquisition of header information of the contents with respect to the server device, and acquire the header information outputted from the server device on the basis of the request; and
a complement unit configured to complement the insufficient amount of information of the metadata by analyzing the header information acquired by the header information acquisition unit.

2. A picture signal processor according to claim 1, further comprising:
a display control unit configured to, when the determination unit determines that the amount of information of the metadata is insufficient, display information of the metadata acquired by the metadata acquisition unit and information of the metadata acquired by the complement unit together on a display unit.

3. A picture signal processor according to claim 2, wherein
the display control unit is configured to create a list of contents stored in the server device on the basis of the information of the metadata, and to display the list on the display unit.

4. A picture signal processor according to claim 3, further comprising:
an operating unit configured to select and display predetermined contents from the list displayed on the display unit.

5. A picture signal processor according to claim 1, wherein
the contents are still image contents, and the information of the metadata complemented by the complement unit is configured to include information relating to any one of an image size and photographing date and time.

6. A picture signal processor according to claim 1, wherein
the contents are moving image contents, and the information of the metadata complemented by the complement unit is configured to include information of a total number of hours.

7. A picture signal processor according to claim 1, wherein
the server device is configured to include any one of a personal computer and a recording/reproducing device for image or sound.

8. A picture signal processing method comprising:
a first block of making a request for acquisition of metadata corresponding to contents with respect to a server device having the contents stored therein, and acquiring the metadata outputted from the server device on the basis of the request;
a second block of determining whether or not an amount of information of the metadata acquired in the first block is insufficient;
a third block of, when it is determined in the second block that the amount of information of the metadata is insufficient, making a request for acquisition of header information of the contents with respect to the server device, and acquiring the header information outputted from the server device on the basis of the request; and
a fourth block of complementing the insufficient amount of information of the metadata by analyzing the header information acquired in the third block.

9. A picture signal processing method according to claim 8, further comprising:
a fifth block of, when it is determined in the second block that the amount of information of the metadata is insufficient, displaying information of the metadata acquired in the first block and information of the metadata acquired in the fourth block together on a display unit.

10. A picture signal processing method according to claim 9, wherein
the fifth block creates a list of contents stored in the server device on the basis of the information of the metadata, and displays the list on the display unit.

11. A picture signal processing method according to claim 10, further comprising:
a sixth block of selecting and displaying predetermined contents from the list displayed on the display unit.

12. A picture signal processing method according to claim 8, wherein
the contents are still image contents, and the information of the metadata complemented in the fourth block includes information relating to any one of an image size and photographing date and time.

13. A picture signal processing method according to claim 8, wherein
the contents are moving image contents, and the information of the metadata complemented in the fourth block includes information of a total number of hours.

14. A picture signal processing method according to claim 8, wherein
the server device includes any one of a personal computer and a recording/reproducing device for image or sound.
